(19) United States
(12) Patent Application Publication
(10) Pub. No.: US 2021/0012202 A1
(43) Pub. Date: Jan. 14, 2021

(54) SYSTEMS AND METHODS FOR ASYMMETRICAL SCALING FACTOR SUPPORT FOR NEGATIVE AND POSITIVE VALUES

(71) Applicant: Facebook Technologies, LLC, Menlo Park, CA (US)

(72) Inventors: Ganesh Venkatesh, San Jose, CA (US); Pierce I-Jen Chuang, Sunnyvale, CA (US)

(73) Assignee: Facebook Technologies, LLC, Menlo Park, CA (US)

(21) Appl. No.: 16/510,616

(22) Filed: Jul. 12, 2019

(51) Int. Cl. G06N 3/08; G06F 5/01; G06N 3/063; G06F 9/38; G06F 7/556

(52) U.S. Cl. CPC G06N 3/082; G06F 5/01; G06F 7/556; G06F 9/3877; G06N 3/063

(57) ABSTRACT

Disclosed herein includes a system, a method, and a device for asymmetrical scaling factor support for negative and positive values. A device can include a circuit having a shift circuitry and multiply circuitry. The circuit can be configured to perform computation for a neural network, including multiplying, via the multiply circuitry, a first value and a second value. The circuit can be configured to perform computation for a neural network, including shifting, via the shift circuitry, a result of the multiplying by a determined number of bits. The circuit can be configured to perform computation for a neural network, including outputting the result of the multiplying when a sign bit of the first value is negative, and a result of the shifting when the sign bit of the first value is positive.

### FIELD OF DISCLOSURE

The present disclosure is generally related to computation in neural networks, including but not limited to a system and method for asymmetrical scaling factor support for values in neural networks.

### BACKGROUND

Artificial intelligence (AI) processing can use different forms of activation functions. The activation functions can generate an output of a node in a neural network given a set of inputs. The activation functions can output either positive or negative values based on the set of inputs. The activation functions can activate one or more neurons in the neural network with positive values and one or more neurons in the neural network with negative values.

### SUMMARY

Devices, systems and methods for supporting asymmetrical scaling factors for negative and positive values are provided herein. A circuit can be designed and configured having hardware components to provide asymmetrical scaling factors for positive values and negative values in multiplier and accumulator circuitry (MAC), for example. In an embodiment, the circuit can include a multiplier component to receive multiple values (e.g., weight value, activation value). The circuit can include a comparator component to determine a sign of at least one value provided to the multiplier component. For example, in an embodiment, the comparator component can determine a sign of an activation value provided to the multiplier component. Responsive to the sign of the value, the circuit can provide different scaling for positive values versus negative values. For example, responsive to a positive value, the circuit can provide the result of the multiplier to a shifting component or circuit to shift the result by a predetermined number of bits. The circuit can provide the result of the shifting component or circuit to a multiplexer component to generate an output for the circuit. Responsive to a negative value, the circuit can provide the result of the multiplier to a multiplexer component (e.g., without shifting operations) to generate an output for the circuit. Thus, the circuit can provide different scaling factors for positive values versus negative values.

In at least one aspect, a device is provided. The device can include a circuit having a shift circuitry and multiply circuitry. The circuit can be configured to perform computation for a neural network, including multiplying, via the multiply circuitry, a first value and a second value. The circuit can be configured to perform computation for a neural network, including shifting, via the shift circuitry, a result of the multiplying by a determined number of bits. The circuit can be configured to perform computation for (e.g., a current or specific layer of) a neural network, including outputting the result of the multiplying when a sign bit of the first value is negative, and a result of the shifting when the sign bit of the first value is positive.

In some embodiments, the circuit can include a multiplexer. The circuit can be configured to output, via the multiplexer according to the sign bit of the first value, the result of the multiplying or the result of the shifting. The first value can include an activation for a first layer (e.g., a prior or previous layer) of the neural network. The determined number of bits can correspond to an exponent with base 2 of a scaling factor of an activation function for the first layer of the neural network. The activation function can include a leaky rectifier linear unit (ReLu) function. The determined number of bits can be m, and m can be an integer equal to or greater than 1. In some embodiments, the determined number of bits can be 2.

In some embodiments, the circuit can include comparator circuitry configured to determine whether the sign bit of the first value is negative or positive. The circuit can include multiplier and accumulator (MAC) circuitry comprising accumulator circuitry. The circuit can be configured to provide a result of the outputting to the accumulator circuitry of the MAC circuitry. In some embodiments, the computation for the neural network can include second multiplying, via the multiply circuitry, a third value and a fourth value. The computation for the neural network can include second shifting, via the shift circuitry, a result of the second multiplying by the determined number of bits. The computation for the neural network can include second outputting the result of the second multiplying when a sign bit of the third value is negative, and a result of the second shifting when the sign bit of the third value is positive. The computation for the neural network can include providing a result of the second outputting to the accumulator circuitry of the MAC circuitry.

In at least one aspect, a method is provided. The method can include multiplying, by multiply circuitry of a circuit, a first value and a second value for a neural network. The method can include shifting, by shift circuitry of the circuit, a result of the multiplying by a determined number of bits. The method can include outputting, by the circuit, the result of the multiplying when a sign bit of the first value is negative, and a result of the shifting when the sign bit of the first value is positive.

In some embodiments, the method can include outputting, via a multiplexer of the circuit based on the sign bit of the first value, the result of the multiplying or the result of the shifting. The first value can include an activation for a first or prior layer of the neural network. The determined number of bits can correspond to an exponent with base 2 of a scaling factor of an activation function for the first layer of the neural network. The activation function can include a leaky rectifier linear unit (ReLu) function. The predetermined number of bits can be m, and m can be an integer equal to or greater than 1. In some embodiments, the determined number of bits can be 2.

In some embodiments, the method can include determining, by comparator circuitry of the circuit, whether the sign bit of the first value is negative or positive. The method can include providing a result of the outputting to accumulator circuitry of the circuit. The method can include second multiplying, via the multiply circuitry, a third value and a fourth value. The method can include second shifting, via the shift circuitry, a result of the second multiplying by the predetermined number of bits. The method can include second outputting the result of the second multiplying when a sign bit of the third value is negative, and a result of the second shifting when the sign bit of the third value is positive. The method can include providing a result of the second outputting to the accumulator circuitry of the circuit.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1A is a block diagram of an embodiment of a system for performing artificial intelligence (AI) related processing, according to an example implementation of the present disclosure.

FIG. 1B is a block diagrams of an embodiment of a device for performing AI) related processing, according to an example implementation of the present disclosure.

FIG. 1C is a block diagram of an embodiment of a device for performing AI related processing, according to an example implementation of the present disclosure.

FIG. 1D is a block diagram of a computing environment according to an example implementation of the present disclosure.

FIG. 2A is a block diagram of a system for asymmetrical scaling factor for negative and positive values, according to an example implementation of the present disclosure.

FIG. 2B is a graph of an activation function, according to an example implementation of the present disclosure.

FIG. 2C is a flow chart illustrating a process or method for asymmetrical scaling factor for negative and positive values, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

For purposes of reading the description of the various embodiments of the present invention below, the following descriptions of the sections of the specification and their respective contents may be helpful:
Section A describes an environment, system, configuration and/or other aspects useful for practicing or implementing an embodiment of the present systems, methods and devices; and
Section B describes embodiments of devices, systems and methods for supporting asymmetrical scaling factors for negative and positive values.

### A. Environment for Artificial Intelligence Related Processing

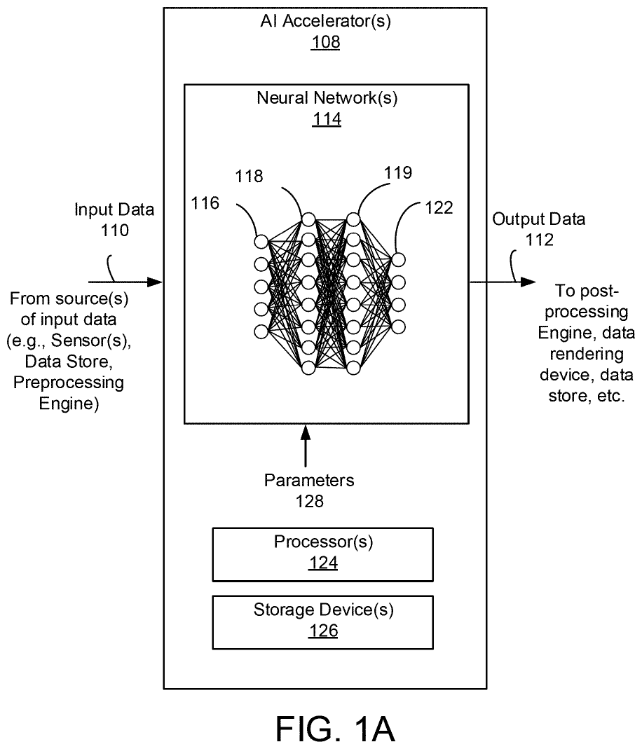

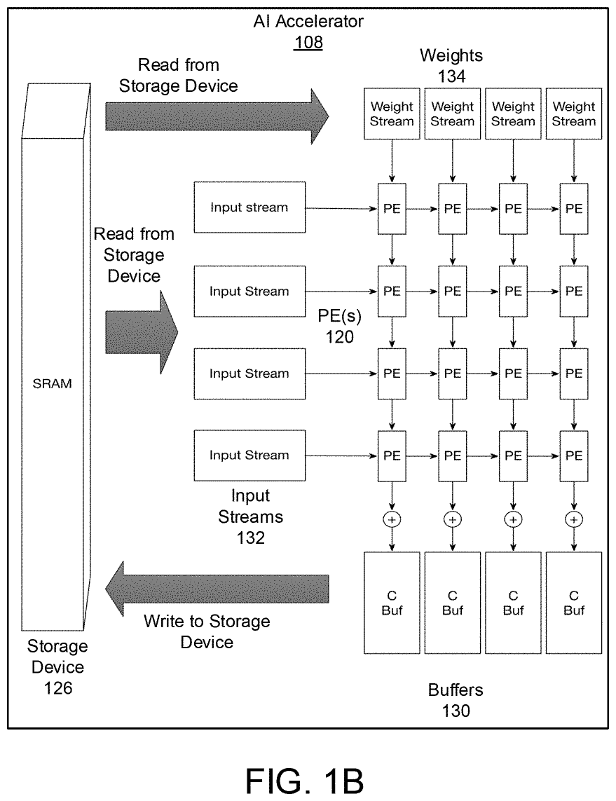

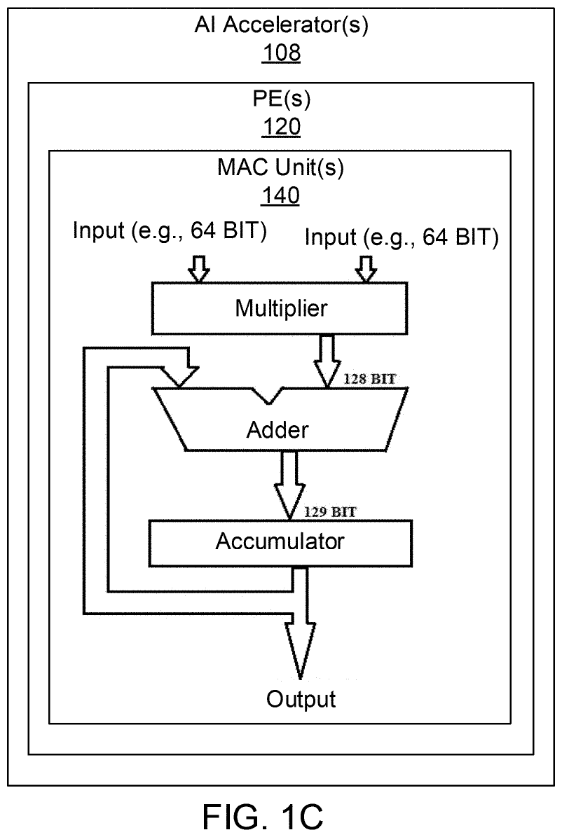

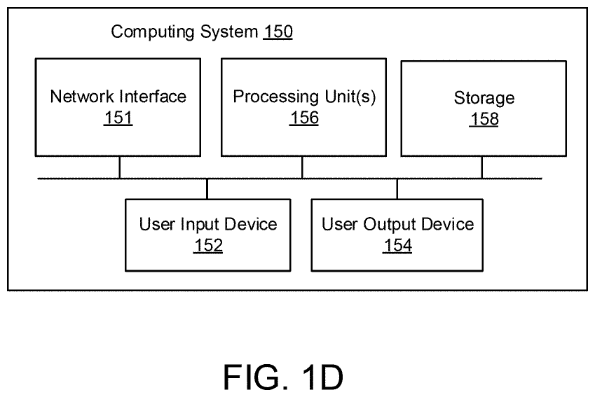

Prior to discussing the specifics of embodiments of systems, devices and/or methods in Section B, it may be helpful to discuss the environments, systems, configurations and/or other aspects useful for practicing or implementing certain embodiments of the systems, devices and/or methods. Referring now to FIG. 1A, an embodiment of a system for performing artificial intelligence (AI) related processing is depicted. In brief overview, the system includes one or more AI accelerators 108 that can perform AI related processing using input data 110. Although referenced as an AI accelerator 108, it is sometimes referred as a neural network accelerator (NNA), neural network chip or hardware, AI processor, AI chip, etc. The AI accelerator(s) 108 can perform AI related processing to output or provide output data 112, according to the input data 110 and/or parameters 128 (e.g., weight and/or bias information). An AI accelerator 108 can include and/or implement one or more neural networks 114 (e.g., artificial neural networks), one or more processor(s) and/or one or more storage devices 12.

Each of the above-mentioned elements or components is implemented in hardware, or a combination of hardware and software. For instance, each of these elements or components can include any application, program, library, script, task, service, process or any type and form of executable instructions executing on hardware such as circuitry that can include digital and/or analog elements (e.g., one or more transistors, logic gates, registers, memory devices, resistive elements, conductive elements, capacitive elements).

The input data 110 can include any type or form of data for configuring, tuning, training and/or activating a neural network 114 of the AI accelerator(s) 108, and/or for processing by the processor(s) 124. The neural network 114 is sometimes referred to as an artificial neural network (ANN). Configuring, tuning and/or training a neural network can refer to or include a process of machine learning in which training data sets (e.g., as the input data 110) such as historical data are provided to the neural network for processing. Tuning or configuring can refer to or include training or processing of the neural network 114 to allow the neural network to improve accuracy. Tuning or configuring the neural network 114 can include, for example, designing the neural network using architectures for that have proven to be successful for the type of problem or objective desired for the neural network 114. In some cases, the one or more neural networks 114 may initiate at a same or similar baseline model, but during the tuning, training or learning process, the results of the neural networks 114 can be sufficiently different such that each neural network 114 can be tuned to process a specific type of input and generate a specific type of output with a higher level of accuracy and reliability as compared to a different neural network that is either at the baseline model or tuned or trained for a different objective or purpose. Tuning the neural network 114 can include setting different parameters 128 for each neural network 114, fine-tuning the parameters 128 differently for each neural network 114, or assigning different weights (e.g., hyperparameters, or learning rates), tensor flows, etc. Thus, by setting appropriate parameters 128 for the neural network(s) 114 based on a tuning or training process and the objective of the neural network(s) and/or the system, this can improve performance of the overall system.

A neural network 114 of the AI accelerator 108 can include any type of neural network including, for example, a convolution neural network (CNN), deep convolution network, a feed forward neural network (e.g., multilayer perceptron (MLP)), a deep feed forward neural network, a radial basis function neural network, a Kohonen self-organizing neural network, a recurrent neural network, a modular neural network, a long/short term memory neural network, etc. The neural network(s) 114 can be deployed or used to perform data (e.g., image, audio, video) processing, object or feature recognition, recommender functions, data or image classification, data (e.g., image) analysis, etc., such as natural language processing.

As an example, and in one or more embodiments, the neural network 114 can be configured as or include a convolution neural network. The convolution neural network can include one or more convolution cells (or pooling layers) and kernels, that can each serve a different purpose. The convolution neural network can include, incorporate and/or use a convolution kernel (sometimes simply referred as “kernel”). The convolution kernel can process input data, and the pooling layers can simplify the data, using, for example, non-linear functions such as a max, thereby reducing unnecessary features. The neural network 114 including the convolution neural network can facilitate image, audio or any data recognition or other processing. For example, the input data 110 (e.g., from a sensor) can be passed to convolution layers of the convolution neural network that form a funnel, compressing detected features in the input data 110. The first layer of the convolution neural network can detect first characteristics, the second layer can detect second characteristics, and so on.

The convolution neural network can be a type of deep, feed-forward artificial neural network configured to analyze visual imagery, audio information, and/or any other type or form of input data 110. The convolution neural network can include multilayer perceptrons designed to use minimal preprocessing. The convolution neural network can include or be referred to as shift invariant or space invariant artificial neural networks, based on their shared-weights architecture and translation invariance characteristics. Since convolution neural networks can use relatively less pre-processing compared to other data classification/processing algorithms, the convolution neural network can automatically learn the filters that may be hand-engineered for other data classification/processing algorithms, thereby improving the efficiency associated with configuring, establishing or setting up the neural network 114, thereby providing a technical advantage relative to other data classification/processing techniques.

The neural network 114 can include an input layer 116 and an output layer 122, of neurons or nodes. The neural network 114 can also have one or more hidden layers 118, 119 that can include convolution layers, pooling layers, fully connected layers, and/or normalization layers, of neurons or nodes. In a neural network 114, each neuron can receive input from some number of locations in the previous layer. In a fully connected layer, each neuron can receive input from every element of the previous layer.

Each neuron in a neural network 114 can compute an output value by applying some function to the input values coming from the receptive field in the previous layer. The function that is applied to the input values is specified by a vector of weights and a bias (typically real numbers). Learning (e.g., during a training phase) in a neural network 114 can progress by making incremental adjustments to the biases and/or weights. The vector of weights and the bias can be called a filter and can represents some feature of the input (e.g., a particular shape). A distinguishing feature of convolutional neural networks is that many neurons can share the same filter. This reduces memory footprint because a single bias and a single vector of weights can be used across all receptive fields sharing that filter, rather than each receptive field having its own bias and vector of weights.

For example, in a convolution layer, the system can apply a convolution operation to the input layer 116, passing the result to the next layer. The convolution emulates the response of an individual neuron to input stimuli. Each convolutional neuron can process data only for its receptive field. Using the convolution operation can reduce the number of neurons used in the neural network 114 as compared to a fully connected feedforward neural network. Thus, the convolution operation can reduces the number of free parameters, allowing the network to be deeper with fewer parameters. For example, regardless of an input data (e.g., image data) size, tiling regions of size 5×5, each with the same shared weights, may use only 25 learnable parameters. In this way, the first neural network 114 with a convolution neural network can resolve the vanishing or exploding gradients problem in training traditional multi-layer neural networks with many layers by using backpropagation.

The neural network 114 (e.g., configured with a convolution neural network) can include one or more pooling layers. The one or more pooling layers can include local pooling layers or global pooling layers. The pooling layers can combine the outputs of neuron clusters at one layer into a single neuron in the next layer. For example, max pooling can use the maximum value from each of a cluster of neurons at the prior layer. Another example is average pooling, which can use the average value from each of a cluster of neurons at the prior layer.

The neural network 114 (e.g., configured with a convolution neural network) can include fully connected layers. Fully connected layers can connect every neuron in one layer to every neuron in another layer. The neural network 114 can be configured with shared weights in convolutional layers, which can refer to the same filter being used for each receptive field in the layer, thereby reducing a memory footprint and improving performance of the first neural network 114.

The hidden layers 118, 119 can include filters that are tuned or configured to detect information based on the input data (e.g., sensor data, from a virtual reality system for instance). As the system steps through each layer in the neural network 114 (e.g., convolution neural network), the system can translate the input from a first layer and output the transformed input to a second layer, and so on. The neural network 114 can include one or more hidden layers 118, 119 based on the type of object or information being detected, processed and/or computed, and the type of input data 110.

In some embodiments, the convolutional layer is the core building block of a neural network 114 (e.g., configured as a CNN). The layer's parameters 128 can include a set of learnable filters (or kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the neural network 114 can learn filters that activate when it detects some specific type of feature at some spatial position in the input. Stacking the activation maps for all filters along the depth dimension forms the full output volume of the convolution layer. Every entry in the output volume can thus also be interpreted as an output of a neuron that looks at a small region in the input and shares parameters with neurons in the same activation map. In a convolutional layer, neurons can receive input from a restricted subarea of the previous layer. Typically the subarea is of a square shape (e.g., size 5 by 5). The input area of a neuron is called its receptive field. So, in a fully connected layer, the receptive field is the entire previous layer. In a convolutional layer, the receptive area can be smaller than the entire previous layer.

The first neural network 114 can be trained to detect, classify, segment and/or translate input data 110 (e.g., by detecting or determining the probabilities of objects, events, words and/or other features, based on the input data 110). For example, the first input layer 116 of neural network 114 can receive the input data 110, process the input data 110 to transform the data to a first intermediate output, and forward the first intermediate output to a first hidden layer 118. The first hidden layer 118 can receive the first intermediate output, process the first intermediate output to transform the first intermediate output to a second intermediate output, and forward the second intermediate output to a second hidden layer 119. The second hidden layer 119 can receive the second intermediate output, process the second intermediate output to transform the second intermediate output to a third intermediate output, and forward the third intermediate output to an output layer 122. The output layer 122 can receive the third intermediate output, process the third intermediate output to transform the third intermediate output to output data 112, and forward the output data 112 (e.g., possibly to a post-processing engine, for rendering to a user, for storage, and so on). The output data 112 can include object detection data, enhanced/translated/augmented data, a recommendation, a classification, and/or segmented data, as examples.

Referring again to FIG. 1A, the AI accelerator 108 can include one or more storage devices 126. A storage device 126 can be designed or implemented to store, hold or maintain any type or form of data associated with the AI accelerator(s) 108. For example, the data can include the input data 110 that is received by the AI accelerator(s) 108, and/or the output data 112 (e.g., before being output to a next device or processing stage). The data can include intermediate data used for, or from any of the processing stages of a neural network(s) 114 and/or the processor(s) 124. The data can include one or more operands for input to and processing at a neuron of the neural network(s) 114, which can be read or accessed from the storage device 126. For example, the data can include input data, weight information and/or bias information, activation function information, and/or parameters 128 for one or more neurons (or nodes) and/or layers of the neural network(s) 114, which can be stored in and read or accessed from the storage device 126. The data can include output data from a neuron of the neural network(s) 114, which can be written to and stored at the storage device 126. For example, the data can include activation data, refined or updated data (e.g., weight information and/or bias information, activation function information, and/or other parameters 128) for one or more neurons (or nodes) and/or layers of the neural network(s) 114, which can be transferred or written to, and stored in the storage device 126.

In some embodiments, the AI accelerator 108 can include one or more processors 124. The one or more processors 124 can include any logic, circuitry and/or processing component (e.g., a microprocessor) for pre-processing input data for any one or more of the neural network(s) 114 or AI accelerator(s) 108, and/or for post-processing output data for any one or more of the neural network(s) 114 or AI accelerator(s) 108. The one or more processors 124 can provide logic, circuitry, processing component and/or functionality for configuring, controlling and/or managing one or more operations of the neural network(s) 114 or AI accelerator(s) 108. For instance, a processor 124 may receive data or signals associated with a neural network 114 to control or reduce power consumption (e.g., via clock-gating controls on circuitry implementing operations of the neural network 114). As another example, a processor 124 may partition and/or re-arrange data for separate processing (e.g., at various components of an AI accelerator 108), sequential processing (e.g., on the same component of an AI accelerator 108, at different times), or for storage in different memory slices of a storage device, or in different storage devices. In some embodiments, the processor(s) 124 can configure a neural network 114 to operate for a particular context, provide a certain type of processing, and/or to address a specific type of input data, e.g., by identifying, selecting and/or loading specific weight, activation function and/or parameter information to neurons and/or layers of the neural network 114.

In some embodiments, the AI accelerator 108 is designed and/or implemented to handle or process deep learning and/or AI workloads. For example, the AI accelerator 108 can provide hardware acceleration for artificial intelligence applications, including artificial neural networks, machine vision and machine learning. The AI accelerator 108 can be configured for operation to handle robotics, interne of things and other data-intensive or sensor-driven tasks. The AI accelerator 108 may include a multi-core or multiple processing element (PE) design, and can be incorporated into various types and forms of devices such as artificial reality (e.g., virtual, augmented or mixed reality) systems, smartphones, tablets, and computers. Certain embodiments of the AI accelerator 108 can include or be implemented using at least one digital signal processor (DSP), co-processor, microprocessor, computer system, heterogeneous computing configuration of processors, graphics processing unit (GPU), field-programmable gate array (FPGA), and/or application-specific integrated circuit (ASIC). The AI accelerator 108 can be a transistor based, semiconductor based and/or a quantum computing based device.

Referring now to FIG. 1B, an example embodiment of a device for performing AI related processing is depicted. In brief overview, the device can include or correspond to an AI accelerator 108, e.g., with one or more features described above in connection with FIG. 1A. The AI accelerator 108 can include one or more storage devices 126 (e.g., memory such as a static random-access memory (SRAM) device), one or more buffers, a plurality or array of processing element (PE) circuits, other logic or circuitry (e.g., adder circuitry), and/or other structures or constructs (e.g., interconnects, data buses, clock circuitry, power network(s)). Each of the above-mentioned elements or components is implemented in hardware, or at least a combination of hardware and software. The hardware can for instance include circuit elements (e.g., one or more transistors, logic gates, registers, memory devices, resistive elements, conductive elements, capacitive elements, and/or wire or electrically conductive connectors).

In a neural network 114 (e.g., artificial neural network) implemented in the AI accelerator 108, neurons can take various forms and can be referred to as processing elements (PEs) or PE circuits. The PEs are connected into a particular network pattern or array, with different patterns serving different functional purposes. The PE in an artificial neural network operate electrically (e.g., in a semiconductor implementation), and may be either analog, digital, or a hybrid. To parallel the effect of a biological synapse, the connections between PEs can be assigned multiplicative weights, which can be calibrated or “trained” to produce the proper system output.

PE can be defined in terms of the following equations (e.g., which represent a McCulloch-Pitts model of a neuron):

ζ=Σᵢwᵢxᵢ (1)

y=σ(ζ) (2)

Where ζ is the weighted sum of the inputs (e.g., the inner product of the input vector and the tap-weight vector), and σ(ζ) is a function of the weighted sum. Where the weight and input elements form vectors w and x, the ζ weighted sum becomes a simple dot product:

ζ=w·x (3)

This may be referred to as either the activation function (e.g., in the case of a threshold comparison) or a transfer function. In some embodiments, one or more PEs can be referred to as a dot product engine. The input (e.g., input data 110) to the neural network 114, x, can come from an input space and the output (e.g., output data 112) are part of the output space. For some network networks, the output space Y may be as simple as {0, 1}, or it may be a complex multi-dimensional (e.g., multiple channel) space (e.g., for a convolutional neural network). Neural networks tend to have one input per degree of freedom in the input space, and one output per degree of freedom in the output space.

Referring again to FIG. 1B, the input x to a PE 120 can be part of an input stream 132 that is read from a storage device 126 (e.g., SRAM). An input stream 132 can be directed to one row (horizontal bank or group) of PEs, and can be shared across one or more of the PEs, or partitioned into data portions (overlapping or non-overlapping portions) as inputs for respective PEs. Weights 134 (or weight information) in a weight stream 134 (e.g., read from the storage device 126) can be directed or provided to a column (vertical bank or group) of PEs. Each of the PEs in the column may share the same weight 134 or receive a corresponding weight 134. The input and/or weight for each target PE can be directly routed (e.g., from the storage device 126) to the target PE, or routed through one or more PEs (e.g., along a row or column of PEs) to the target PE. The output of each PE can be routed directly out of the PE array, or through one or more PEs (e.g., along a column of PEs) to exit the PE array. The outputs of each column of PEs can be summed or added at an adder circuitry of the respective column, and provided to a buffer 130 for the respective column of PEs. The buffer(s) 130 can provide, transfer, route, write and/or store the received outputs to the storage device 126. In some embodiments, the outputs (e.g., activation data from one layer of the neural network) that are stored to the storage device 126 can be retrieved or read from the storage device 126, and be used as inputs to the array of PEs 120 for processing (of a subsequent layer of the neural network) at a later time. In some embodiments, the outputs that are stored to the storage device 126 can be retrieved or read from the storage device 126 as output data 112 for the AI accelerator 108.

Referring now to FIG. 1C, one example embodiment of a device for performing AI related processing is depicted. In brief overview, the device can include or correspond to an AI accelerator 108, e.g., with one or more features described above in connection with FIGS. 1A and 1B. The AI accelerator 108 can include one or more PEs 120, other logic or circuitry (e.g., adder circuitry), and/or other structures or constructs (e.g., interconnects, data buses, clock circuitry, power network(s)). Each of the above-mentioned elements or components is implemented in hardware, or at least a combination of hardware and software. The hardware can for instance include circuit elements (e.g., one or more transistors, logic gates, registers, memory devices, resistive elements, conductive elements, capacitive elements, and/or wire or electrically conductive connectors).

In some embodiments, a PE 120 can include one or more multiply-accumulate (MAC) units or circuits 140. One or more PEs can sometimes be referred to as a MAC engine. A MAC unit is configured to perform multiply-accumulate operation(s). The MAC unit can include a multiplier circuit, an adder circuit and/or an accumulator circuit. The multiply-accumulate operation computes the product of two numbers and adds that product to an accumulator. The MAC operation can be represented as follows, in connection with an accumulator a, and inputs b and c:

a←a+(b×c) (4)

In some embodiments, a MAC unit 140 may include a multiplier implemented in combinational logic followed by an adder (e.g., that includes combinational logic) and an accumulator register (e.g., that includes sequential and/or combinational logic) that stores the result. The output of the accumulator register can be fed back to one input of the adder, so that on each clock cycle, the output of the multiplier can be added to the register.

As discussed above, a MAC unit 140 can perform both multiply and addition functions. The MAC unit 140 can operate in two stages. The MAC unit 140 can first compute the product of given numbers (inputs) in a first stage, and forward the result for the second stage operation (e.g., addition and/or accumulate). An n-bit MAC unit 140 can include an n-bit multiplier, 2n-bit adder, and 2n-bit accumulator.

Various systems and/or devices described herein can be implemented in a computing system. FIG. 1D shows a block diagram of a representative computing system 150. In some embodiments, the system of FIG. 1A can form at least part of the processing unit(s) 156 of the computing system 150. Computing system 150 can be implemented, for example, as a device (e.g., consumer device) such as a smartphone, other mobile phone, tablet computer, wearable computing device (e.g., smart watch, eyeglasses, head mounted display), desktop computer, laptop computer, or implemented with distributed computing devices. The computing system 150 can be implemented to provide VR, AR, MR experience. In some embodiments, the computing system 150 can include conventional, specialized or custom computer components such as processors 156, storage device 158, network interface 151, user input device 152, and user output device 154.

Network interface 151 can provide a connection to a local/wide area network (e.g., the Internet) to which network interface of a (local/remote) server or back-end system is also connected. Network interface 151 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 152 can include any device (or devices) via which a user can provide signals to computing system 150; computing system 150 can interpret the signals as indicative of particular user requests or information. User input device 152 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 154 can include any device via which computing system 150 can provide information to a user. For example, user output device 154 can include a display to display images generated by or delivered to computing system 150. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 154 can be provided in addition to or instead of a display. Examples include indicator lights, speakers, tactile “display” devices, printers, and so on.

Some implementations include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 156 can provide various functionality for computing system 150, including any of the functionality described herein as being performed by a server or client, or other functionality associated with message management services.

It will be appreciated that computing system 150 is illustrative and that variations and modifications are possible. Computer systems used in connection with the present disclosure can have other capabilities not specifically described here. Further, while computing system 150 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

### B. Methods and Devices for Supporting Asymmetrical Scaling Factors for Negative and Positive Values

Disclosed herein include embodiments of a system, a method, and a device for asymmetrical scaling factor for negative and positive values. For example, and in some embodiments, a circuit can be designed having one or more hardware components or circuitry to provide asymmetrical scaling factors for positive values and negative values in multiplier and accumulator circuitry (MAC). The hardware components or circuitry can include multiply circuitry, shift circuitry, comparator circuitry, and/or a multiplexer. The multiply circuitry can receive values (also referred as operands), such as weight and activation values for a neural network operation (e.g., a convolution or multiply operation) of an activation function for example. The multiply circuitry can scale an activation value with a weight value for instance, by multiplying these values together. The multiply circuitry can provide a result of multiplying the values to the shift circuitry and the multiplexer, to support asymmetrical scaling. The shift circuitry can shift the result of the multiplying a determined amount of bits, to modify or further scale the result and provide the shifted result (e.g., scaled asymmetrically relative to the original result of the multiplying) to the multiplexer. The comparator circuitry can determine a sign of at least one value or operand (e.g., weight value for one layer of the neural network, or activation value from a prior layer of the neural network) or an expected sign of an output of the operation or activation function for the one layer, and generate a sign indication signal to be used as a selection signal for the multiplexer. For example, responsive to a positive value, the circuit can, via the multiplexer, output the shifted result from the shift circuitry as being based on a first scaling factor in accordance with the activation function. The first scaling factor can refer to an absolute value of the activation value (sometimes referred to as activation) multiplied by two to the power N, where N is a number of bit shifts performed by the shift circuitry. Responsive to a negative value, the circuit can, via the multiplexer, output the result of the multiply circuitry (e.g., the result of the multiplying) as being based on a second scaling factor in accordance with the activation function. The second scaling factor can refer to an absolute value of the activation value for instance. Thus, the circuit can provide different scaling factors for positive values versus negative values responsive to the sign of at least one value or operand (or an output of the multiply operation or activation function).

The scaling factors generated, provided, selected and/or adopted by the circuit can include or represent a trade-off or balance between different types of error correction. For example, the scaling factors applied by the circuit can be selected or determined to reduce or minimize a combination of quantization error and clipping error. However, when compensating or correcting for quantization error, the scaling factor can negatively impact the clipping error and when compensating or correcting for clipping error, the scaling factor can negatively impact the quantization error. For example, for a fixed-point representation, a larger scaling factor can provide or imply a smaller clipping error (e.g., since larger number can be represented) at the cost of a higher quantization error (e.g., since the number of bits between 0 to the scaling factor is fixed). For activation at a node of a neural network, where the input is multiplied with a scalar number, if the number is negative in value, the corresponding output can have a different slope for a positive value versus a negative number. Therefore either the negative values or the positive values can be compromised, because when compensating or correcting for one type of error for positive values, an error factor for the negative values can increase, and when compensating or correcting for one type of error for negative values, an error factor for the positive values can increase. For example, if the scaling factor is selected such that it minimizes the combination of quantization and clipping error for the positive elements, the sum of errors for negative elements can be large due to an unnecessarily large dynamic range caused by adopting the same scaling factor.

The systems, methods, and devices described here can provide asymmetrical scaling factors for negative and positive values, e.g., to reduce or minimize a combination of quantization error and clipping error for applications, such as but not limited to, machine learning applications. The positive values and negative values can be scaled by different factors or operations (e.g., multiplication, bit shift, or both) to reduce or minimize a combination of quantization error and clipping error and not compromise either the negative values or the positive values computed or generated by an operation, activation function and/or process of a neural network. A circuit can be configured in a MAC unit or engine to provide the asymmetrical scaling factors, with reduced or minimal hardware overhead. For example, the circuit can include multiplier circuitry, shift circuitry, a comparator element and/or a multiplexer element to receive operands (e.g., weight values and activation values) and generate an output that provides asymmetrical scaling factors for negative and positive values. For example, the multiplier circuitry can multiply a first value and a second value (e.g., weight value, activation value). The multiplier circuitry can provide the multiplication result to the shift circuitry and the multiplexer. The shift circuitry can shift the multiplication result by a predetermined number of bits and can provide the shifted result to the multiplexer. The comparator can determine a sign (e.g., positive or negative) of at least one of the values, and can provide a sign indication to the multiplexer. Thus, the multiplexer can receive the multiplication result, the shifted result and the sign indication of at least one value. In some embodiments, responsive to the sign of the value, the multiplexer can output the multiplication result or the shifted result. For example, responsive to a positive sign, the multiplexer can output the shifted result which represents an activation value multiplied or scaled by a positive scaling factor (e.g., a value of the weight value multiplied by two to the power N, where N is a number of bit shifts performed by the shift circuitry), and responsive to a negative sign, the multiplexer can output the multiplication result which represents the activation value multiplied or scaled by a negative scaling factor (e.g., a value of the weight value). In some embodiments, the positive and negative scaling factors can be predetermined. For example, in some embodiments, the positive and negative scaling factors can be set to have a power of two relationship. By way of an example, the positive scaling factor can be k(2^{N}), and the negative scaling factor can be k, where k can be any value (e.g., integer, decimal or otherwise). Thus, the circuit can provide a first scaling factor for positive values and a second, different scaling factor for negative values.

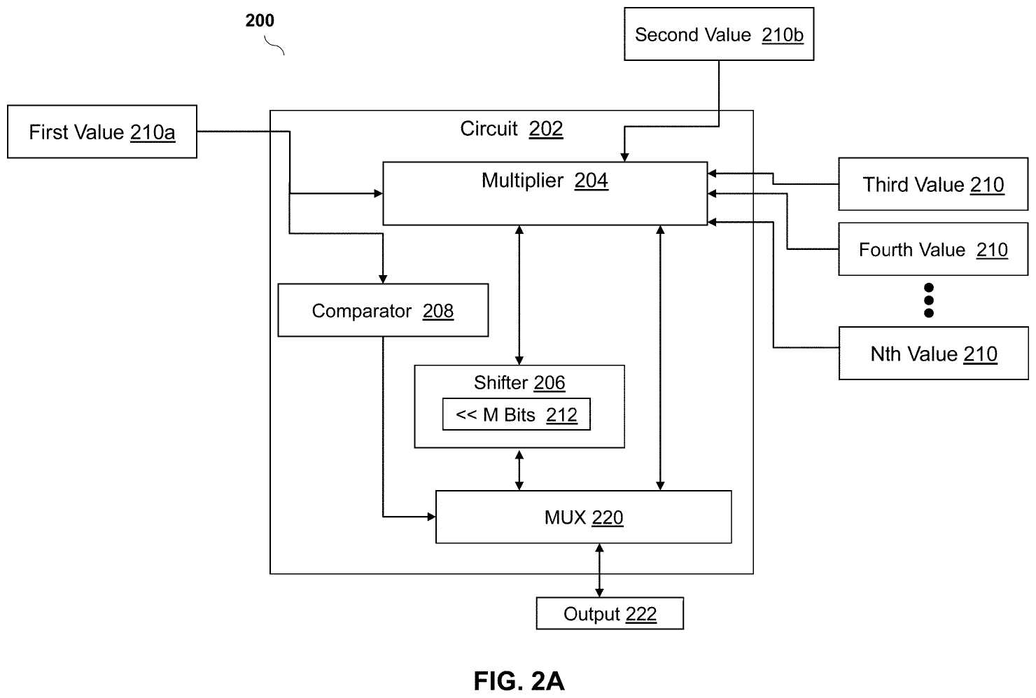

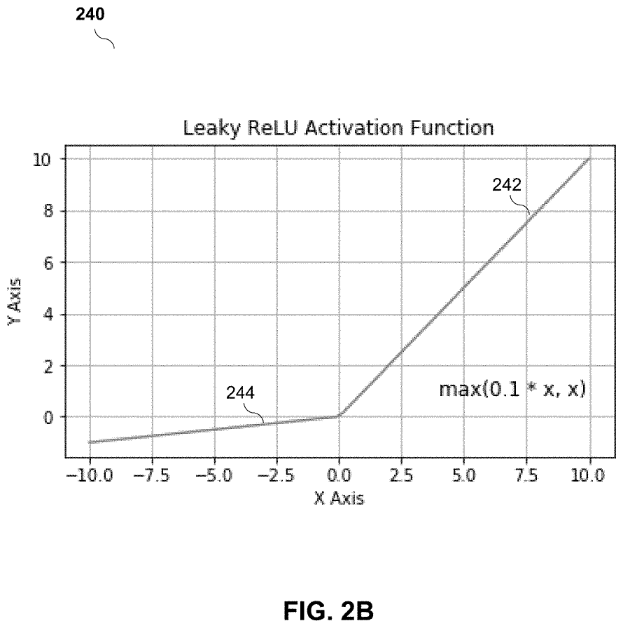

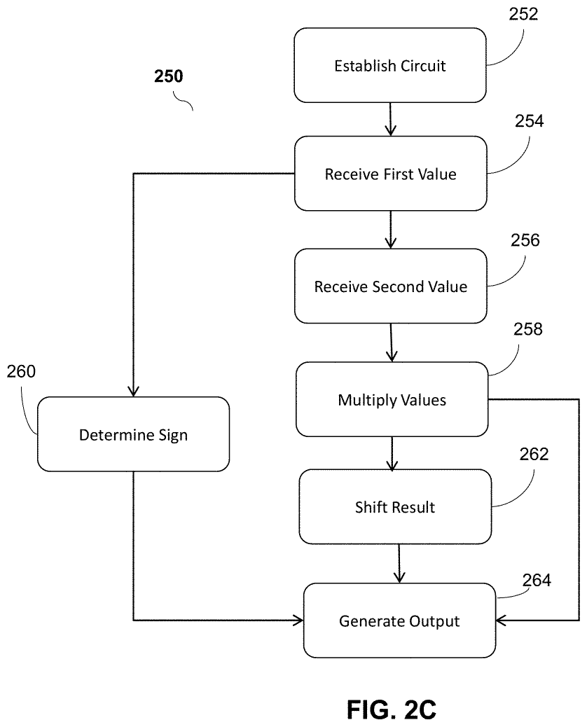

Referring now to FIG. 2A, an embodiment of a system 200 for providing asymmetrical scaling factors for negative and positive values is depicted. In brief overview, the system 200 can include a circuit 202 having multiply circuitry 204, shift circuitry 206, comparator circuitry 208, and/or a multiplexer 220. The circuit 202 can provide asymmetrical scaling factors for positive values and negative values based in part on a sign of at least one value provided to the circuit.

The circuit 202 can include a processor such as but not limited to processor(s) 124 described above with respect to FIG. 1A. In some embodiments, the circuit 202 can be a component of or part of the AI accelerator 108 described above with respect to FIG. 1B. In some embodiments, the circuit 202 can be a component of or part of a processing element (PE) of an AI accelerator system, such as PE(s) 120 of FIG. 1B. The circuit 202 can be or include a MAC unit 140 (for example as described in connection with FIG. 1C. The circuit 202 can be configured to perform AI related processing. For example, the circuit 202 can be configured to provide output data used for configuring, tuning, training and/or activating a neural network, such as a neural network 114 of the AI accelerator(s) 108 of FIG. 1A. In some embodiments, the circuit 202 can be a component of or part of computing system 150 described above with respect to FIG. 1D. The circuit 202 can include a memory. For example, the circuit 202 can include a memory coupled with one or more processors. The memory can include a static random access memory (SRAM) as an example. In some embodiments, the memory can include, be the same as or substantially similar to storage device 126 of FIGS. 1A-1B or storage 158 of FIG. 1D.

The multiply circuitry 204 can include or be implemented in hardware, or at least a combination of hardware and software. The multiply circuitry 204 can correspond to a multiplier of a MAC unit 140. In some embodiments, the multiply circuitry 204 can include a multiplier or an electronic circuit to multiply at least two values (e.g., in binary number form or other form). The multiply circuitry 204 can include an electronic circuit to take or produce a dot product of vectors (e.g., of matrices) or perform a dot product summation on at least two matrices (e.g., weight matrix, activation matrix). A dot product can refer to a result or output of performing a dot product operation on operands (e.g., which can include vectors, matrices and/or other inputs or values). The multiply circuitry 204 can be configured to receive two values 210, for example, from an input stream, weight stream and/or other form of input to circuit 202, and can multiply the respective values 210 to generate a multiplication result 205. The multiplication result 205 can include or correspond to a product of at least two values or a dot product of vectors for instance. For example, the multiply circuitry 204 can scale an activation value 210 with a weight value 210 by multiplying the activation value 210 by the weight value 210. The multiply circuitry 204 can provide the multiplication result 205 to the shift circuitry 206 and the multiplexer 220, to support asymmetrical scaling.

The shift circuitry 206 can include or be implemented in hardware, or at least a combination of hardware and software. The shift circuitry 206 can include an electronic circuitry to shift, scale, increase, decrease or otherwise modify one or more bits 212 of the multiplication result 205 to generate a shifted result 207. The shift circuitry 206 can be configured to implement a bit shift operation to shift one or more bits of the multiplication result 205 in a first or second direction, and scale (e.g., increase, decrease) the multiplication results 205 based in part on a direction of the shift and/or a determined number of bits 212 of the shift. The shift circuitry 206 can scale the multiplication result 205 by the determined number of bits 212 to provide asymmetrical scaling relative to the multiplication result 205. For example, the shift circuitry 206 can shift the multiplication result by a determined number of bits 212 corresponding to a shift factor or scale factor. The determined number of bits 212 can be an integer greater than 1. In one embodiment, and by way of an example, the determined number of bits 212 can be equal to 2 (e.g., to provide or contribute a scale factor of 2²=4). In some embodiments, the determined number of bits 212 translates to an amount of scaling equal to an exponent with base 2, which forms part of a scaling factor of an activation function for a first layer of a neural network, such as but not limited to neural network 114 of FIG. 1A. In some embodiments, the activation function can include a leaky rectifier linear unit (ReLu) function. The shift circuitry 206 can be configured to shift the multiplication result 205 from the multiply circuitry 204 by the determined number of bits 212 to generate a shifted result 207. The shifted result 207 can correspond to a further scaled version of the multiplication result 205. The shifted result 207 can incorporate a scaling factor that includes an exponent with base 2, that is part of an activation function (e.g., ReLu function) for at least one layer of a neural network, such as but not limited to neural network 114 of FIG. 1A.

The comparator circuitry 208 can include or be implemented in hardware, or at least a combination of hardware and software. In some embodiments, the comparator circuitry 208 can include a comparator or an electronic circuit configured to compare at least one value 210 (as a first input) to a reference value (as a second input), and generate a sign indication signal 209 indicating which of the inputs is larger. For example, the comparator circuitry 208 can be configured to compare a first value 210a to a reference signal to determine a sign of the first value 210a or whether or not the first value 210a is positive or negative. The comparator circuitry 208 can include a comparator or an electronic circuit configured to compare a sign bit or a sign of at least one value 210 to a reference value and generate a sign indication signal 209 indicating whether or not the respective value 210a is positive or negative. As referenced herein, a sign bit of a value 210 that is referenced as being positive or negative means that the value 210 is (or has a sign that is) positive or negative respectively, and/or that the sign bit has a value that indicates that the value 210 is (or has a sign that is) positive or negative respectively.

The multiplexer 220 can include or be implemented in hardware, or at least a combination of hardware and software. The multiplexer 220 can include a plurality of inputs and be configured to select between the respective inputs and forward the selected input to an output line. The output line of the multiplexer can be the same as or correspond to the output 222 of the circuit 202. The multiplexer 220 can select between the inputs based in part on a selection signal or the sign indication signal 209 received from the comparator circuitry 208. For example, the multiplexer 220 can include an input configured to receive the multiplication result 205 from the multiply circuitry 204, an input configured to receive the shifted result 207 from the shift circuitry 206, and an input configured to receive the sign indication signal 209 from the comparator circuitry 208. The multiplexer 220 can select the multiplication result 205 or the shifted result 207 based in part on the sign indication signal 209. In some embodiments, the multiplexer 220 can generate an output 222 that corresponds to or is equal to the multiplication result 205 or the shifted result 207, based at least in part on the sign indication signal 209 and whether or not a value 210 is positive or negative.

In some embodiments, the circuit 202 can include multiplier and accumulator (MAC) circuitry having accumulator circuitry. For example, the circuit 202 can include one or more MAC units 140 described above with respect to FIG. 1C. The circuit 202 can provide the output 222 to an adder and/or accumulator of a MAC unit 140, which can process the output 222. At least one output of the multiplexer 220 can provide the output 222 of the circuit 202 to the adder and/or accumulator of the MAC unit 140.

The values 210 as described herein can include weight values or activation values used in a neural network for AI related processing. For example, the values 210 can include any form of data described herein, such as intermediate data used for, or from any of the processing stages, nodes and/or layers of a neural network(s) 114 and/or the processor(s) 124 of FIG. 1A. The values 210 can include input data, weight information and/or bias information, activation function information, and/or parameters 128 for one or more neurons (or nodes) and/or layers of the neural network(s) 114, which can be stored in and read or accessed from the storage device 126 for instance. For example, the values 210 can include values or data from an input stream, such as but not limited to, input streams 132 described above with respect to FIG. 1B. The values 210 can include a kernel or a dot product of two vectors (e.g., vectors of a weight matrix, vectors of an activation matrix). In some embodiments, the values 210 include a weight value, weight scaling factor, weight matrix or any other weight information provided by a weight stream. For example, the values 210 can include a weight for a first layer of the neural network, such as a weight 134 as described above with respect to FIG. 1B. The values can include an activation value, activation scaling factor, activation matrix or any other activation information.

Referring now to FIG. 2B, an embodiment of a graph 240 of a leaky rectifier linear unit (ReLu) activation function is provided. The circuits 202 described herein can provide asymmetrical scaling factors for activation functions, including leaky ReLu activation functions. The graph 240 can show the result of a convolution or dot product operation, as an example. In one illustrative embodiment, the graph 240 can be represented by the following convolution operation (C):

C=(W_{scaling}*Wᵢₙₜ)*(A_{scaling}*Aᵢₙₜ)=(W_{scaling}*A_{scaling})*(A_{scaling}*Aᵢₙₜ) (5)

Where C represents the output of the convolution operation, W_{scaling} represents a weight scalar scaling factor, Wᵢₙₜ represents an integer representation of a matrix of weight values, A_{scaling} represents an activation scalar scaling factor, and Aᵢₙₜ represents an integer representation of a matrix of activation values. The weight scaling factor can determine or represent an upper-threshold of the weight that it can represent. For example, if the weight scaling factor is equal to 1 and an 8-bit linear quantization is assumed, the maximum weight output can be equal to 1*127=127. The activation scaling factor can provide similar results. As illustrated in graph 240, the positive values 242 (of an output of an activation function) can have a different slope than the negative values 244. The circuit 202 can generate an output 222 that incorporates different scaling factors for positive values 242 versus negative values 244. In some embodiments, the scaling factor difference provided to the positive values 242 versus the negative values 244 can have a power of two relationship. For example, the weight scalar scaling factor (W_{scaling}) for positive values 242 can be four times the weight scalar scaling factor (W_{scaling}) for negative values 244. The circuits 202 described herein can provide a first scaling factor for positive values 242 and a second, different scaling factor for negative values 244. In one embodiment, during a dot-product summation for a current or specific layer of the neural network, if the first value 210a or activation value (from a prior layer) is for example determined to be a positive value (such that the corresponding activation function output is expected to be a positive value 242), the output 222 generated by the circuit 202 can be shifted by two bits. The multiplexer 220 can provide the shifted result 207 to the output 222 of the circuit 202 responsive to the comparator circuitry 208 determining that the first value 210a or activation value is a positive value 242. The output 222 can be scaled and/or generated to reduce or minimize a combination of quantization error and clipping error for an activation function for at least one layer of a neural network.

Although this disclosure may discuss that a scalar scaling factor for positive values for certain activation values and/or outputs of activation functions, can be larger than a scaling factor for negative values. The converse can be true for some other activation values, kernels and/or activation functions for example. For instance, and in some scenarios, a scalar scaling factor for negative values for some activation values and/or outputs of activation functions, can be larger than a scaling factor for positive values.

Now referring to FIG. 2C, a method 250 for providing asymmetrical scaling factors for positive and negative values is provided. In brief overview, the method 250 can include establishing a circuit (252), receiving a first value (254), receiving a second value (256), multiplying values (258), shifting the multiplication result (260), determining a sign of a value (262), and generating an output (264).

At operation 252, and in some embodiments, a circuit 202 can be established, provided and/or configured to have multiply circuitry 204, shift circuitry 206, comparator circuitry 208, and/or a multiplexer 220. The multiply circuitry 204 can include multiply circuitry or circuit components to receive multiple values 210 and to generate a multiplication result 205. For example, the multiply circuitry 204 can include multiple inputs with each input configured to receive at least one value 210. In some embodiments, the multiplication result 205 can include a dot product or a convolution output, for example. The multiply circuitry 204 can be configured to transmit the multiplication result 205 to the shift circuitry 206 and the multiplexer 220. For example, the multiply circuitry 204 can include one or more outputs with the one or more outputs configured to provide the multiplication result 205 to at least one input of the shift circuitry 206 and at least one input of the multiplexer 220. The shift circuitry 206 can include shift circuit, bit wise operator, sequential logic and/or circuit components to modify or shift a value by a determined or defined number of bits and generate a shifted result 207, and/or to scale the value (e.g., multiplication result 205) by a determined or defined factor to generate the shifted result 207. The shift circuitry 206 can be configured to provide the shifted result 207 to the multiplexer. For example, the shift circuitry 206 can include at least one output configured to provide the shifted result 207 to at least one input of the multiplexer 220.

The comparator circuitry 208 can be configured to receive one or more values 210, and can determine properties of the values 210. For example, the comparator circuitry 208 can include at least one input configured to receive a first value 210a and/or a second value 210b. The comparator circuitry 208 can include a comparator or circuit components to determine if a sign or sign bit of a value 210 is positive or negative, and generate a sign indication signal 209 indicating the sign of the respective value 210. The comparator circuitry 208 can be configured to provide the sign indication signal to the multiplexer. For example, the comparator circuitry 208 can include at least one output configured to provide the sign indication signal 209 to at least one input of the multiplexer 220. The multiplexer 220 can include one or more circuit components to receive one or more inputs (e.g., sign indication signal 209, multiplication result 205, shifted result) and provide an output 222 for circuit 202. For example, the multiplexer 220 can select between the multiplication result 205 and the shifted result 207 based in part on the sign indication signal 209, and can output either the multiplication result 205 or the shifted result 207 responsive to the sign indication signal 209. The multiplexer 220 can provide different scaling factors for positive values versus negative values responsive to the sign of at least one value 210 or operand (or an output of the multiply operation or activation function). For example, the shift circuitry 206 can provide a first scaling factor and the multiply circuitry 204 can provide a second scaling factor. The multiplexer 220 can select between the shifted result 207 from the shift circuitry 206 and the multiplication result 205 from the multiply circuitry 204 based in part on the sign indication signal 209 to provide different scaling factors for positive values 210 versus negative values 210.

At operation 254, a first value 210a can be received. The multiply circuitry 204 can receive a first value 210a from at least one stream or read from a storage device (e.g., storage device 126 of FIG. 1B). The first value 210a can include any form of data described herein, such as intermediate data used for, or from any of the processing stages of a neural network(s) 114 and/or the processor(s) 124 of FIG. 1A. The data can include input data, weight information and/or bias information, activation function information, and/or parameters 128 for one or more neurons (or nodes) and/or layers of the neural network(s) 114, which can be stored in and read or accessed from the storage device 126. For example, the first value 210a can include a weight value, weight scaling factor or weight matrix provided by a weight stream. The first value 210a can include a weight for a current or specific layer of the neural network. For example, the first value 210a can include a weight 134 described above with respect to FIG. 1B. The first value 210a can include an activation value, activation scaling factor or activation matrix. The first value 210a can include an activation value for a first or prior layer of the neural network (e.g., a layer prior to the current or specific layer). In some embodiments, the first value 210a can include input data, kernel information or bias information. For example, the first value 210a can be received from an input stream, such as but not limited to, input streams 132 described above with respect to FIG. 1B.

At operation 256, a second value 210b can be received. The second value 210b can include any form of data described herein, such as intermediate data used for, or from any of the processing stages of a neural network(s) 114 and/or the processor(s) 124 of FIG. 1A. The data can include input data, weight information and/or bias information, activation function information, and/or parameters 128 for one or more neurons (or nodes) and/or layers of the neural network(s) 114, which can be stored in and read or accessed from the storage device 126. The multiply circuitry 204 can receive a second value 210b that is different from the first value 210a. For example, the second value 210b can include a different type of value as compared to the first value 210. In some embodiments, if the first value 210a includes a weight value, weight scaling factor, weight matrix, bias information, or kernel information, the second value 210b can include an activation value, activation scaling factor or activation matrix. In some embodiments, if the first value 210a includes an activation value, activation scaling factor or activation matrix, the second value 210b can include a weight value, weight scaling factor, weight, bias information, or kernel information. In some embodiments, the multiply circuitry 204 can receive the second value 210b from at least one stream or read from a storage device (e.g., storage device 126 of FIG. 1B). For example, the second value 210b can include a weight value, weight scaling factor or weight matrix provided by a weight stream. The second value 210b can include a weight for a first layer of the neural network. For example, the second value 210b can include a weight 134 described above with respect to FIG. 1B. The second value 210b can include an activation value, activation scaling factor or activation matrix. In some embodiments, the second value 210b can include input data, kernel information or bias information. For example, the second value 210b can be received from an input stream, such as but not limited to, input streams 132 described above with respect to FIG. 1B.

At operation 258, the values 210a, 210b can be multiplied. The multiply circuitry 204 can multiply the first value 210a and the second value 210b in a computation for a neural network. The multiply circuitry 204 can be configured to perform a multiplication of the first value 210a by the second value 210b to generate a multiplication result 205. In some embodiments, the first value 210a can include an activation value and the second value 210b can include a weight value. The multiply circuitry 204 can scale the activation value 210 by multiplying the activation value 210 by the weight value 210. The multiplication result 205 can include a product of the first value 210a and the second value 210b. The multiplication result 205 can include a product of an activation value 210 multiplied or scaled by a weight value 210. In some embodiments, the first and second values 210a, 210b can include or correspond to a matrix of values. In some embodiments, the first and second values 210a, 210b can include or correspond to an integer representation of a matrix. The multiply circuitry 204 can perform or take a dot product of the first value 210a and the second value 210b to generate a multiplication result 205. In some embodiments, the multiply circuitry 204 can perform a dot product summation of the first value 210a and the second value 210b to generate the multiplication result 205. The multiply circuitry 204 can include at least one output configured to provide the multiplication result 205 to at least one input of the shift circuitry 206. In some embodiments, if the first value 210a includes an activation value for a first or prior layer of the neural network (e.g., a layer prior to the current or specific layer), the output of the multiply circuitry 204 can be based at least in part on or correspond to the activation of the first or prior layer of the neural network. The multiply circuitry 204 can include at least one output configured to provide the multiplication result 205 to at least one input of the multiplexer 220.

At operation 260, and in one or more embodiments, the multiplication result 205 can be shifted. The shift circuitry 206 can shift a result 205 (e.g., in bit form) of the multiplying by a determined number of bits 212 (or bit positions). In some embodiments, the shift circuitry 206 can receive the multiplication result 205, and can modify or further scale the multiplication result 205 by shifting the multiplication result 205 by the determined number of bits 212. The determined number of bits 212 can be represented by M, and M can be an integer of 1 (or any other integer value, positive or negative). In one embodiments, the determined number of bits 212 can be equal to 2 and thus M can be equal to 2. In some embodiments, the determined number of bits 212 can translate or contribute to a scaling factor (e.g., an exponent with base 2) in an activation function for the first (or prior) layer of the neural network. The activation function can include, but is not limited to, a leaky rectifier linear unit (ReLu) function. The shifting of the bits 212 can scale or modify the multiplication result 205 based in part on a direction of the shift and/or the predetermined number of bits 212. For example, the shift circuitry 206 can shift the bits of the multiplication result 205 in a first direction (e.g., left direction, <<) by M bits to scale the multiplication result 205 (e.g., multiply the result by 2^{M}) or shift the bits of the multiplication result 205 in a second direction (e.g., right direction, >>) by M bits to scale the multiplication result 205 (e.g., divide the result by 2^{M}). In some embodiments, the shift circuitry 206 can shift or further scale the multiplication results 205 by 2 bits in the left direction to scale the multiplication result 205 by 4, and generate a shifted result 207. The shift circuitry 206 can include at least one output configured to provide the shifted result 207 to at least one input of the multiplexer 220.

At operation 262, and in some embodiments, a sign of a value 210 can be determined. The comparator circuitry 208 of the circuit 202 can determine whether the sign bit or value/sign of the first value 210a is negative or positive. In some embodiments, the comparator circuitry 208 of the circuit 202 can determine whether the sign bit or a value/sign of the second value 210b is negative or positive. The comparator circuitry 208 of the circuit 202 can determine whether an expected sign/value of an output of the operation or activation function would be negative or positive. The sign bit of the first value 210a can indicate that the first value 210a is positive or negative. The sign bit of the second value 210b can indicate that the second value 210b is positive or negative. The comparator circuitry 208 can compare a reference signal to the sign bit of the first value 210a or the sign bit of the second value 210b. In some embodiments, the reference signal can include a zero (or other) value and the comparator circuitry 208 can compare the first value 210a or the second value 210b to the reference signal to determine whether the respective value 210 is positive or negative (e.g., relative to the reference signal). In some embodiments, the reference signal can include a zero bit value (e.g., 0) and the comparator circuitry 208 can compare the sign bit of the first value 210a or the sign bit of the second value 210b to the zero reference signal to determine whether the respective value 210 is positive or negative. For example, if the first value 210a or the second value 210b is greater than the zero reference signal, the comparator circuitry 208 can output an indication of a positive value. If the first value 210a or the second value 210b is less than or equal to the zero reference signal, the comparator circuitry 208 can output an indication of a negative value.

The comparator circuitry 208 can generate a sign indication signal 209 indicating whether the respective value 210 is positive or negative. For example, the comparator circuitry 208 can generate a sign indication signal 209 indicating whether the first value 210a is positive or negative. In some embodiments, the comparator circuitry 208 can generate a sign indication signal 209 indicating whether the second value 210b is positive or negative. The comparator circuitry 208 can include at least one output configured to provide the sign indication signal 290 to at least one input of the multiplexer 220.

At operation 264, and in some embodiments, an output signal 222 can be generated. In some embodiments, the circuit 202 can output the result 205 of the multiplying when a sign bit of the first value 210a is negative, and a result 207 of the shifting when the sign bit of the first value 210a is positive. The circuit 202 can include the multiplexer 220 to select between multiple inputs based in part on a sign of at least one value 210. The multiplexer 220 can include a plurality of inputs and at least one output, and can selectively provide a value provided to at least one input to its respective output based in part on a selector input. For example, the multiplexer 220 can receive the multiplication result 205 from the multiply circuitry 204, the shifted result 207 from the shift circuitry 206, and the sign indication signal 209 from the comparator circuitry 208. The circuit 202, via the multiplexer 220 and based on the sign bit of the first value 210a, can output the result 205 of the multiplying or the result 207 of the shifting.

The circuit 202 can use the multiplexer 220 to provide different scaling factors for positive values versus negative values responsive to the sign of at least one value 210 or operand (or an output of the multiply operation or activation function). In some embodiments, responsive to the sign indication signal 209 indicating a positive value, the multiplexer 220 can output the shifted result 207 from the shift circuitry 206 as being based on a first scaling factor in accordance with the activation function. The first scaling factor can refer to an absolute value of the weight value 210 multiplied by two to the power N, where N is a number of bit shifts performed by the shift circuitry 206. The multiplexer 220 can provide the shifted result 207 to the output 222 of the circuit 202 as a first scaled output 222 scaled relative to the multiplication result 205. In some embodiments, responsive to the sign indication signal 209 indicating a negative value, the circuit 202 output the result 205 of the multiply circuitry 204 (e.g., the result of the multiplying) as being based on a second scaling factor in accordance with the activation function. The second scaling factor can refer to an absolute value of the weight value 210 for instance. The multiplexer 220 can provide the multiplication result 205 to the output 222 of the circuit 202 as a second scaled output 222 scaled relative to the shifted result 207. Thus, the circuit 202 can support asymmetric scaling for positive values 210 and negative values 210 by providing different scaling factors based in part on the respective value 210 being a positive value 210 or a negative value 210.

In some embodiments, the sign indication signal 209 can include or correspond to a selector input that the multiplexer 220 can use to select between the multiplication result 205 from the multiply circuitry 204 and the shifted result 207 from the shift circuitry 206. Responsive to a value or sign indicated by the sign indication signal 209, the multiplexer can provide either the multiplication result 205 or the shifted result 207 to an output 222 of the circuit 202. In some embodiments, the sign indication signal 209 can indicate that the first value 210a is a positive value and the multiplexer 220 can provide the shifted result 207 from the shift circuitry 206 as the output 222 of the circuit 202. For example, the circuit 202 can determine that the first value 210a is a positive value and output the shifted result 207 to minimize or reduce a combination of quantization error and clipping error for positive elements or positive values outputted by for instance a processing element 120 of the AI accelerator 108 of FIG. 1B.

In some embodiments, the sign indication signal 209 can indicate that the first value 210a is a negative value, and responsive to this, the multiplexer 220 can provide the multiplication result 205 from the multiply circuitry 204 as the output 222 of the circuit 202. For example, the circuit 202 can determine that the first value 210a is a negative value, and responsive to this, output the multiplication result 205 to minimize or reduce a combination of quantization error and clipping error for negative elements or negative values outputted by for instance a processing element 120 of the AI accelerator 108 of FIG. 1B.

The output 222 of the circuit 202 can be fed back into a neural network and used for configuring, tuning, training and/or activating the neural network, such as a neural network 114 of the AI accelerator(s) 108 of FIG. 1A. In some embodiments, the circuit 202 can receive subsequent values 210 and can continually generate outputs 222 to provide asymmetrical scaling factors for positive values and negative values. For example, the circuit 202 can perform second multiplying or subsequent multiplying, via the multiply circuitry 204, on a third value 210 and a fourth value 210 or subsequent values 210, respectively. The circuit 202 can perform, via the shift circuitry 206, second shifting or subsequent shifting, on a result 205 of the second multiplying by the predetermined number of bits 212 or on a result 205 of the subsequent multiplying by the predetermined number of bits 212. The circuit 202 can perform second outputting the result 205 of the second multiplying when a sign bit of the third value 210 is negative, and a result 207 of the second shifting when the sign bit of the third value 210 is positive. The circuit 202 can provide a result 222 of the second outputting to the accumulator circuitry 140 of the circuit 202. In some embodiments, the circuit 202 can perform subsequent outputting of subsequent results 205 of the subsequent multiplying when a sign bit of the subsequent values 210 is negative, and a result 207 of subsequent shifting when the sign bit of the subsequent values 210 is positive. The circuit 202 can provide subsequent results 222 of the subsequent outputting to the accumulator circuitry 140 of the circuit 202.

In some embodiments, the circuit 202, through the multiplexer 220, can provide a result of the outputting or the output 222 to accumulator circuitry of the circuit 202. For example, the circuit 202 can include multiplier and accumulator (MAC) circuitry having the accumulator circuitry. The multiplier and accumulator (MAC) circuitry having the accumulator circuitry can be the same as or substantially similar to a MAC unit 140 described above with respect to FIG. 1C. The circuit 202 can provide one or more outputs 222 to an accumulator circuitry or an accumulator register of the MAC unit 140, for processing.

Although this disclosure may describe determining if a value 210, or a sign or sign bit of the value 210 is positive or negative, to select between outputs scaled by different amounts, it should be understood that this is merely by way of example and not intended to be limiting in any way. For example, instead of determining between positive and negative values (e.g., in a positive-negative configuration), the present systems, methods and devices can include determining if a value is larger or smaller than (or positive or negative relative to) a reference value or threshold (e.g., in a larger-smaller configuration), and similarly perform a selection between outputs scaled by different amounts. For example, the comparator circuitry 208 can be configured to perform such a determination, and other circuitry or elements can be adapted to operate in a manner similar to embodiments of the positive-negative configuration discussed herein. Further, in certain embodiments under positive-negative configurations, similar operations can be performed where positive values and negative values may be switched or reversed with each other. Similarly, in certain embodiments under larger-smaller configurations, similar operations can be performed where larger values and smaller values may be switched or reversed with each other.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device comprising:
a circuit comprising shift circuitry and multiply circuitry, and configured to perform computation for a neural network, comprising:
multiplying, via the multiply circuitry, a first value and a second value;
shifting, via the shift circuitry, a result of the multiplying by a determined number of bits; and
outputting the result of the multiplying when a sign bit of the first value is negative, and a result of the shifting when the sign bit of the first value is positive.

2. The device according to claim 1, wherein:
the circuit further comprises a multiplexer, and
the circuit is configured to output, via the multiplexer according to the sign bit of the first value, the result of the multiplying or the result of the shifting.

3. The device according to claim 1, wherein the first value comprises an activation for a first layer of the neural network.

4. The device according to claim 3, wherein the determined number of bits corresponds to an exponent with base 2 of a scaling factor of an activation function for the first layer of the neural network.

5. The device according to claim 4, wherein the activation function comprises a leaky rectifier linear unit (ReLu) function.

6. The device according to claim 1, wherein the determined number of bits is m, and m is an integer greater than 1.

7. The device according to claim 1, wherein the determined number of bits is 2.

8. The device according to claim 1, wherein the circuit further comprises comparator circuitry configured to determine whether the sign bit of the first value is negative or positive.

9. The device according to claim 1, wherein
the circuit includes multiplier and accumulator (MAC) circuitry comprising accumulator circuitry, and
the circuit is further configured to provide a result of the outputting to the accumulator circuitry of the MAC circuitry.

10. The device according to claim 9, wherein the computation for the neural network further comprises:
second multiplying, via the multiply circuitry, a third value and a fourth value;
second shifting, via the shift circuitry, a result of the second multiplying by the determined number of bits;
second outputting the result of the second multiplying when a sign bit of the third value is negative, and a result of the second shifting when the sign bit of the third value is positive; and
providing a result of the second outputting to the accumulator circuitry of the MAC circuitry.

11. A method comprising:
multiplying, by multiply circuitry of a circuit, a first value and a second value for a neural network;
shifting, by shift circuitry of the circuit, a result of the multiplying by a determined number of bits; and
outputting, by the circuit, the result of the multiplying when a sign bit of the first value is negative, and a result of the shifting when the sign bit of the first value is positive.

12. The method according to claim 11, comprising outputting, via a multiplexer of the circuit based on the sign bit of the first value, the result of the multiplying or the result of the shifting.

13. The method according to claim 11, wherein the first value comprises an activation for a first layer of the neural network.

14. The method according to claim 13, wherein the determined number of bits corresponds to an exponent with base 2 of a scaling factor of an activation function for the first layer of the neural network.

15. The method according to claim 14, wherein the activation function comprises a leaky rectifier linear unit (ReLu) function.

16. The method according to claim 11, wherein the predetermined number of bits is m, and m is an integer greater than 1.

17. The method according to claim 11, wherein the determined number of bits is 2.

18. The method according to claim 11, further comprising determining, by comparator circuitry of the circuit, whether the sign bit of the first value is negative or positive.

19. The method according to claim 11, further comprising providing a result of the outputting to accumulator circuitry of the circuit.

20. The method according to claim 19, further comprising:
second multiplying, via the multiply circuitry, a third value and a fourth value;
second shifting, via the shift circuitry, a result of the second multiplying by the predetermined number of bits;
second outputting the result of the second multiplying when a sign bit of the third value is negative, and a result of the second shifting when the sign bit of the third value is positive; and
providing a result of the second outputting to the accumulator circuitry of the circuit.
